(19) United States
(12) Patent Application Publication
(10) Pub. No.: US 2010/0034647 A1
(43) Pub. Date: Feb. 11, 2010

(54) Processes for the formation of positive features on shroud components, and related articles

(75) Inventors: Ching-Pang Lee, Cincinnati, OH (US); Hsin-Pang Wang, Rexford, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: General Electric Company

(21) Appl. No.: 11/635,749

(22) Filed: Dec. 7, 2006

(51) Int. Cl. F02C 7/12; B23K 26/00

(52) U.S. Cl. 415/177; 219/121.66

(57) ABSTRACT

A process for the formation of positive features on the surface of a turbine shroud component is described. The process involves applying a feature-forming material to a selected portion of the component surface with a laser consolidation apparatus, according to a pre-selected shape and size for the positive features. A gas turbine engine, comprising a shroud component which contains positive features formed according to embodiments of this process, represents another embodiment of this invention. Methods for modifying the shape of at least one positive feature on a surface of a shroud component are also described.

### BACKGROUND OF THE INVENTION

This invention relates generally to turbine engine components. More specifically, the invention relates to processes for the formation of features on components which require enhanced cooling surfaces.

Gas turbine engines typically have operating temperatures on the order of about 1000-1700° C. The overall efficiency of the engines is directly proportional to the temperature of the turbine gases flowing along the hot gas path and driving the turbine blades. Various techniques have been devised to maintain the temperature of the turbine engine components below critical levels. As an example, coolant air from the engine compressor is often directed through the component, along one or more component surfaces. Such flow is understood in the art as “backside air flow,” where coolant air is directed at a surface of an engine component that is not directly exposed to high temperature gases from combustion. In combination with backside air flow, various surface features have been used to enhance heat transfer. Examples include “turbulators”, which are protuberances or “bumps” on selected sections of the surface of the component. The turbulators function to increase the heat transfer, in conjunction with a coolant medium that is passed along the surface.

Shroud components are good examples of turbine parts which sometimes require features to enhance cooling efficiency. The shrouds in modern high pressure turbines are typically formed to provide an enhanced cooling surface on the back-side, recessed portion of the shroud. Typically, an annular array of shrouds encompasses the hot gas path. The surface of each shroud, which, in part, defines that hot gas path, must be cooled. As alluded to above, a cooling medium such as compressor discharge air (or, in more advanced turbines, steam), is directed against the back side cooling surface of the shroud, to maintain the temperature of the shroud within acceptable limits.

In recent times, high pressure turbine shrouds have also been provided with surface features for heat transfer/cooling enhancement. For example, surface roughness elements have been applied to the back sides, serving to increase the cooling surface area and improve the overall cooling for the shroud. Traditionally, the roughness elements have been applied to the part by way of casting.

Other methods for applying the roughness elements to shrouds and other components have also been developed. Examples include electrochemical machining (ECM) processes. One such process is described in U.S. Pat. No. 6,379,528 (Lee et al). Such a process employs an electrode, in the shape of a recessed, back side of the shroud, which defines a pattern of insulated and non-insulated regions. When an electrolyte is passed over the surface, followed by the application of an electrical current, raised features (i.e., the roughness elements) are formed, with spaces between the features.

Electrochemical machining processes have considerable advantages over casting processes for making the raised features. For example, the shrouds in older turbines may not have enhanced cooling surfaces, and it may be desirable to provide the features when the shrouds are refurbished or returned from the field for repair. While casting is not usually an option for providing the roughness surface elements on existing shroud surfaces, ECM techniques can be employed to effectively deposit the features in a desired pattern.

The ECM processes can usually be carried out in an efficient and cost-effective manner, to provide the desired surface features to various sections of a shroud component. However, while the ECM techniques are very useful in many situations, they have drawbacks for certain applications. For example, it may sometimes be difficult to use an ECM technique to form surface features which have a full, 3-dimensional geometry, because of the need to position the electrode in a certain position relative to the designated location of the features. Furthermore, the ECM techniques usually require the removal of material from the substrate itself, e.g., so as to define positive features adjacent the excavated material. In some instances, the removal of material from the surface can weaken the substrate in certain locations.

With these considerations in mind, it should be apparent that new methods for providing various features (such as roughness) on the surface of turbine shroud components would be welcome in the art. The methods should be capable of forming the features according to precise shape and size characteristics. Moreover, the methods should not involve the removal of material from the shroud surface itself. Furthermore, the methods should be capable of efficiently depositing the features on the surface, according to a pre-selected pattern.

### BRIEF DESCRIPTION OF THE INVENTION

One embodiment of this invention is directed to a process for the formation of positive features on the surface of a turbine shroud component. The process comprises the step of applying a feature-forming material to a selected portion of the component surface with a laser consolidation apparatus, according to a pre-selected shape and size for the positive features. A gas turbine engine, comprising a shroud component which contains positive features formed according to embodiments of this process, represents another embodiment of this invention.

Another embodiment is directed to a process for the formation of positive features as a pattern of roughness on the back side surface of a turbine shroud component. The process comprises the following steps:

(i) melting a feature-forming material with a computer-controlled laser beam, and depositing the molten material onto the back side surface to form a first layer in the pattern of a first cross-section of the feature, the thickness of the first deposited layer corresponding to the thickness of the first cross-section;

(ii) melting a feature-forming material with the laser beam and depositing the molten material to form a second layer in the pattern of a second cross-section of the feature, at least partially overlying the first layer of deposited material, the thickness of the second deposited layer corresponding to the thickness of the second cross-section; and then

(iii) melting a feature-forming material with the laser beam and depositing the molten material to form successive layers in patterns of corresponding cross-sections of the feature, at least one of the successive cross-sections partially overlying the underlying cross-section, wherein the molten material is deposited and the successive layers are formed until the roughness pattern is complete.

An additional embodiment of the present invention relates to a process for modifying the shape of at least one positive feature on a surface of a shroud component. The process comprises the step of using a laser consolidation system to apply additional feature-forming material to the portion of an existing positive feature requiring shape-modification, according to a designated pattern, so that the feature is modified to a pre-selected shape.

Other features and advantages of the invention will be more apparent from the following detailed description of the invention.

### BRIEF DESCRIPTION OF THE DRAWINGS

FIG. 1 is a perspective view of a prior art shroud for a gas turbine.

FIG. 2 is a schematic illustration of a laser consolidation system.

FIG. 3 is a detailed, schematic illustration of a laser consolidation apparatus.

FIG. 4 is an exaggerated side-view, in cross-section, of a surface on which exemplary positive features are being formed by laser consolidation.

FIG. 5 is another exaggerated side-view, in cross-section, of a surface on which exemplary positive features are being formed by laser consolidation.

FIG. 6 is a cross-sectional view of various types of positive features formed on a substrate, according to embodiments of the present process.

FIG. 7 is a perspective view of a gas turbine shroud, illustrating, in exaggerated form, positive features which have been formed on the back side of the shroud.

### DETAILED DESCRIPTION OF THE INVENTION

A typical gas turbine shroud is illustrated in FIG. 1, generally designated as element 10. As those skilled in the art understand, the shroud, in conjunction with other, similar shrouds, forms an annular array which defines, in part, the hot gas path of gas turbine. FIG. 1 is a view of the recessed back side of the shroud, having a smooth surface, i.e., without any features thereon. The opposite surface of the shroud is exposed to the hot gas path, and usually lies directly adjacent the bucket tips of the rotor of the gas turbine.

As shown in FIG. 1, shroud 10 includes a back side recessed cooling surface 12, surrounded by side and end walls 14 and 16. In a typical arrangement, a cooling medium such as compressor discharge air or steam flows into the recess through an impingement plate, not shown, for impingement upon the cooling surface 12. As illustrated in FIG. 1, the cooling surface 12 is smooth, which is typical of the shrouds of older gas turbines. The actual size of a shroud can vary considerably, depending in large part on its specific end use. In the case of gas turbine engines, a typical shroud might have a width of about 3 cm to about 15 cm, and a length of about 3 cm to about 20 cm. The height of the shroud, e.g., the height of end wall 14 in FIG. 1, is usually in the range of about 1 cm to about 4 cm.

According to embodiments of the present invention, positive features are formed on the recessed surface 12 of the shroud. Usually, the positive features are applied for the purpose of cooling enhancement, although it is possible they could perform other functions in various portions of a shroud component, or in adjacent areas of a turbine engine. The positive features can be in many different shapes. Non-limiting examples include mounds, hemispheres, hemispherical sections, diamonds, cones, circular pins, plateaus, ridges, dimples, and elongated ribs. As described further below, the shape and size of the positive features is determined in large part by their intended function. It should also be understood that the term “positive features” is meant to describe features which are added to a surface. In other words, they are not formed by the removal of surrounding material within a surface, as in the case of ECM techniques.

The positive features of this invention are formed by a laser consolidation process. Such a process is generally known in the art, and is referred to by a variety of other names as well. They include “laser cladding”, “laser welding”, “laser engineered net shaping”, and the like. (“Laser consolidation” or “laser deposition” will usually be the terms used herein). Non-limiting examples of the process are provided in the following U.S. patents, which are incorporated herein by reference: U.S. Pat. Nos. 6,429,402 (Dixon et al); 6,269,540 (Islam et al); 5,043,548 (Whitney et al); 5,038,014 (Pratt et al); 4,730,093 (Mehta et al); 4,724,299 (Hammeke); and 4,323,756 (Brown et al). Information on laser consolidation cladding is also provided in many other references, such as “Deposition of Graded Metal Matrix Composites by Laser Beam Cladding”, by C. Thieler et al., BIAS Bremen Institute (10 pages), at http://www.bias.de/aboutus/structure/Imb/Publikationen/Deposition%20of %20graded.pdf (undated, with June 2005 website address).

In general, laser beam consolidation processes typically involve the feeding of a consumable powder or wire into a melt pool on the surface of a substrate. The substrate is usually a base portion of the article to be formed by the process. The melt pool is generated and maintained through the interaction with the laser beam, which provides a high-intensity heat source. As described by C. Thieler et al, the substrate is scanned relative to the beam. As the scanning progresses, the melted substrate region and the melted deposition material solidify, and a clad track is deposited on the surface. A layer is successively formed by tracks deposited side-by-side. Multilayer structures are generated by depositing multiple tracks on top of each other.

The material which forms the positive features can vary considerably, but of course depends in part on the purpose of the features, as well as the material forming the shroud, e.g., the composition of cooling surface 12. (The material should also be capable of application to the surface by laser consolidation). Very often (though not always), the feature material is similar or identical to that of the substrate on which the feature is being applied.

Examples of materials from which the positive features can be formed include metallic, ceramic, or cermet materials. Various types of metals, metal alloys, or metallic composites could be employed. Non-limiting examples include aluminum, titanium, steel (e.g., stainless steel), superalloys, and refractory metal intermetallic composite (RMIC) materials (e.g., those based on niobium and silicon). When the shroud is used in a gas turbine engine, it is usually formed of a superalloy material, and in that instance, the positive features would also usually be formed of a superalloy material. As used herein, the term “superalloy” embraces complex cobalt- nickel-, or iron-based alloys which include one or more other elements, such as chromium, hafnium, rhenium, aluminum, tungsten, molybdenum, and titanium.

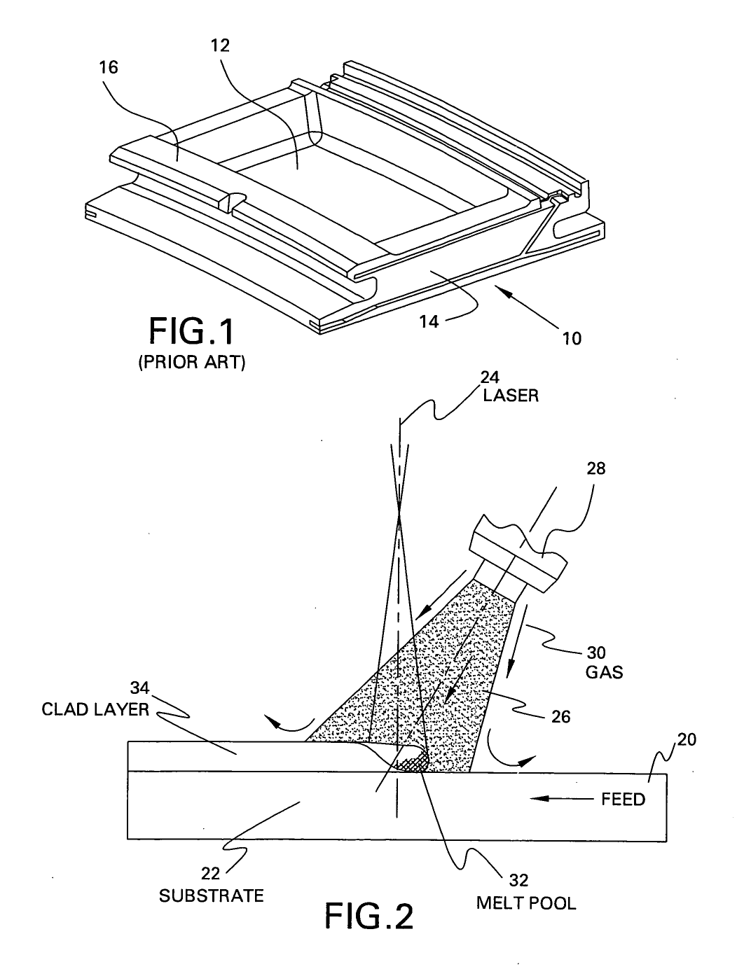

FIG. 2 is a simple illustration setting forth the general principles of a laser consolidation process. Formation of a desired article is taking place on surface 20 of substrate 22, e.g., a positive feature, as described below. Laser beam 24 is focused on a selected region of the substrate, according to conventional laser parameters described below. The feed material (deposition material) 26 is delivered from powder source 28, usually by way of a suitable carrier gas 30. The feed material is usually directed to a region on the substrate which is very close to the point where the energy beam intersects substrate surface 20. Melt pool 32 is formed at this intersection, and solidifies to form clad track 34. Multiple clad tracks deposited next to each other usually form a desired layer. As the deposition apparatus is incremented upwardly, the article progresses toward completion in 3-dimensional form.

As further described below, deposition of the feed material can be carried out under computerized motion control. One or more computer processors can be used to control the movement of the laser, the feed material stream, and the substrate. In general, computer-controlled laser consolidation according to this invention usually begins with an analysis of the desired positive feature as being an assembly of sections or “slices” which are substantially parallel to each other. The feature is then uniquely defined by specifying the pattern of each section, i.e., its shape and size, and the position of each section, in relation to the adjacent sections.

More specifically, those skilled in the art of computer-aided design (e.g., CAD-CAM) understand that the desired article (i.e., the positive feature) can initially be characterized in shape from drawings, or from an article previously formed by conventional methods such as casting, machining, and the like. Once the shape of the article is numerically characterized, the movement of the article (or equivalently, the deposition head) is programmed for the laser deposition apparatus, using available numerical control computer programs. These programs create a pattern of instructions as to the movement of the part during each “pass” of the deposition implement, and its lateral displacement between passes. The resulting feature reproduces the shape of the numerical characterization quite accurately, including complex curvatures or the like. U.S. Pat. No. 5,038,014, referenced above, describes many other details regarding this type of deposition technique. U.S. Pat. Nos. 6,429,402 and 6,269,540, are also instructive in this regard.

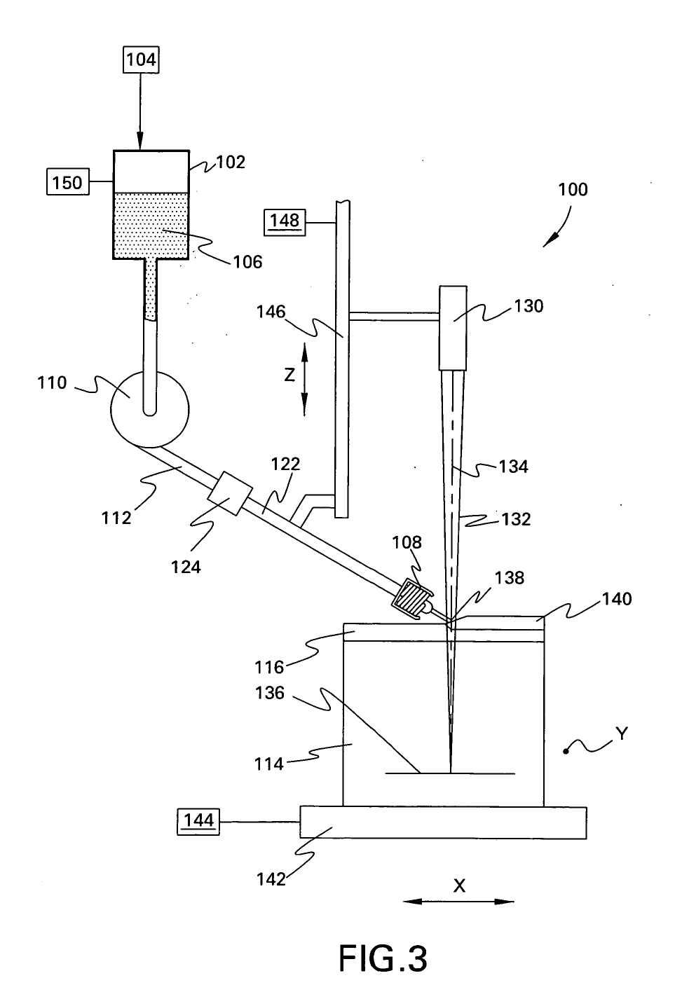

FIG. 3 is a general illustration of one type of laser cladding apparatus which is suitable for embodiments of this invention. Apparatus 100 includes a feed material reservoir 102. Reservoir 102 can be supplied by a supply chamber 104. The supply chamber contains the ceramic powder for the positive feature. Conventional powder delivery systems often entrain the powder-particulate in a gas stream, e.g., an inert gas carrier which can be delivered from a separate gas supply source. (In addition to assisting in powder transport, the inert gas can also function to maintain powder in reservoir 102 under pressure). Details regarding such gas systems need not be included here. Reservoir 102 can be heated (e.g., by heating coils), so as to minimize moisture content in the powder supply.

With continued reference to FIG. 3, various mechanisms are available for carrying feed material 106 to powder delivery nozzle 108. As a non-limiting example, a conventional powder feed wheel 110, which is commercially available, could be employed. Alternatively, many other types of volumetric feeders are available, e.g., auger mechanisms, disc mechanisms, and the like. The powder wheel is cooperatively attached to conduit 112, which carries feed material 106 to delivery nozzle 108. Vibrating device 124, which can be in the form of a variety of mechanisms, is associated with conduit 112. The vibrating device inhibits powder particles moving through the conduit from adhering to its walls.

Conduit 112 terminates in the powder delivery nozzle 108 (sometimes referred to herein as the “powder head”). The powder head (usually assisted by a pressurized, inert gas) directs the powder to an upper surface of substrate (positive feature) 114, or to the surface of a previously-deposited layer 116. The shape and size of the powder head can vary to a great extent. The powder head can also be formed from a variety of materials, such as copper, bronze, aluminum, steel, or ceramic materials. As described in U.S. Pat. No. 5,038,014, the powder head is usually fluid-cooled, as by water, to enhance uniform flow of the powder. Fluid cooling also prevents the powder head from heating excessively as the laser beam passes through the head, or as energy from the melt pool (“weldpool”) is reflected back toward the powder head.

Apparatus 100 further includes a laser 130. The laser emits a beam 132, having a beam axis 134. A wide variety of conventional lasers could be used, provided they have a power output sufficient to accomplish the melting function discussed herein. Carbon dioxide lasers operating within a power range of about 0.1 kw to about 30 kw are typically used, although this range can vary considerably. Non-limiting examples of other types of lasers which are suitable for this invention are Nd:YAG lasers, fiber lasers, diode lasers, lamp-pumped solid state lasers, diode-pumped solid state lasers, and excimer lasers. These lasers are commercially available, and those skilled in the art are very familiar with their operation. The lasers can be operated in either a pulsed mode or a continuous mode.

Laser beam 132 usually has a focal plane 136 beneath the substrate surface. The focal plane is calculated to provide a selected beam spot 138 at the surface of the substrate. The size of the beam spot is usually in the range of about 0.2 mm to about 5 mm in diameter. However, the size can vary considerably, and may sometimes be outside of this range. The laser energy is selected so as to be sufficient to melt a pool of material generally coincident with the beam spot 138. Usually, the laser energy is applied with a power density in the range of about 10³ to about 10⁷ watts per square centimeter.

As mentioned above, the layers of material are usually deposited by feeding powder 106 through conduit 112 into the molten pool at the beam spot 138. As relative lateral movement is provided between the laser beam spot and the article carrying its superimposed powder, progressive melting, cooling and solidification of the molten interaction zone occurs, producing a “bead” or layer. FIG. 3 depicts the first layer 116 of deposited material, while deposition of the next layer 140 is in progress. The angle at which the powder is fed can vary considerably, and is usually in the range of about 25°-70°, relative to the article surface. Those skilled in the laser deposition arts will be able to readily adjust the powder delivery angle to suit a particular situation, based on factors known in the art.

As shown in FIG. 3, the substrate 114 can be supported on a movable support 142. Support 142 can move the substrate in two linear directions: the “X” direction (both X and −X), and the “Y” direction (both Y and −Y, out of the plane of the illustration of FIG. 3). By controlling the combination of the X and Y direction-movement of support 142, while maintaining conduit 112 and laser 130 at a constant height, a well-defined layer can be deposited on the substrate, having the precise pattern (shape) for that particular section of the turbine blade.

In most instances, movement of support 142 along the first linear axis X and the second linear axis Y is carried out by some form of computerized motion control, e.g., using processor 144. A wide variety of computer-control systems can be employed. Most of them typically employ a CAD/CAM interface in which the desired pattern of movement is programmed.

Moreover, support table 142 can be used in conjunction with one or more additional support platforms, to further increase the directions in which support 142 (and substrate 114) can be manipulated. For example, the support platforms could be part of a complex, multi-axis computer numerically controlled (CNC) machine. These machines are known in the art and commercially-available. The use of such a machine to manipulate a substrate is described in a co-pending application for S. Rutkowski et al, Ser. No. 10/622,063, filed on Jul. 17, 2003, and incorporated herein by reference. As described in Ser. No. 10/622,063, the use of such a machine allows movement of the substrate along one or more rotational axes, relative to linear axes X and Y. As an example, a conventional rotary spindle (not shown in FIG. 3) could be used to provide rotational movement.

As shown in the embodiment of FIG. 3, the conduit 112 and laser 130 are rigidly supported on an apparatus support 146. The support is movable in the vertical “Z” direction (and the −Z direction), as shown in the figure. In this manner, conduit 112 and laser 130 can be raised or lowered.

In some embodiments, apparatus support 146 can be controlled by a processor 148, which can function cooperatively with processor 144. In this manner, support 146 and support 142 can be moved in at least three dimensions, relative to the article being formed. For example, by controlling the combination of the X- and Y-direction movement of support 142, while maintaining conduit 112 and laser 130 at a constant “Z” height, a well-defined layer can be deposited on the substrate. The layer, e.g., layer 140, would conform to the pattern required for the positive feature being formed. (As those skilled in the art understand, the same type of X, Y, and Z movement could be carried out by manipulating support 142 in the Z direction, while manipulating support 146 in the X and Y direction).

As depicted in FIG. 3, as one layer is deposited, e.g., layer 116, the apparatus 100 is incremented upwardly. As the apparatus is raised, conduit 112 and laser 130 are also raised, by an amount chosen to be the height or thickness of second layer 140. In this manner, layer 140 can be formed, overlying layer 116. (Again, FIG. 3 illustrates the deposition process at a stage when first layer 116 has been completely deposited, and second layer 140 is partially deposited). As layer 140 is deposited, an upper portion of layer 11,6 is usually re-melted. In this manner, the mixing and structural continuity of the adjacent layers is ensured.

As mentioned above, the composition for the positive feature can be provided by feed material from supply chamber 104. A conventional tube or conduit can connect the feed chamber to feed material reservoir 102. Various types of volumetric feeders like those mentioned above could be used for the feed chamber. The powder can be gravity-fed to reservoir 102, and/or can be carried through with a carrier gas. Reservoir 102 can include conventional devices for mixing the feature-forming material (and any other ingredients), and for minimizing the amount of moisture retained therein. An optional processor 150 functions to coordinate the supply of feature-forming material to the reservoir. Thus, processor 150 can function in conjunction with processors 148 and 144. Coordination of all of the processors is based on the multi-axial movement of the substrate; its location and position at a particular point in time (i.e., the number of layers which have been formed over the substrate), and the pattern of computerized instructions which provide the specific composition for the next layer or set of layers in forming the positive feature.

As those skilled in the art understand, a processor like element 150 may refer, collectively, to a number of sub-processors. Moreover, it may be possible that all of the processors (144, 148, and 150) featured in FIG. 3 can be combined, e.g., their functions would be handled by a single processor. Those skilled in the arts, e.g., with a working knowledge of CNC systems and powder deposition, will be able to devise the best control system for a given situation, without undue effort. Other details regarding a typical laser cladding process, using an apparatus like that of FIG. 3, are provided in various references, such as U.S. Pat. No. 5,038,014.

However, it should be emphasized that many variations are possible in regard to the laser and powder delivery systems for a laser consolidation process. In general, they are all within the scope of this invention, and need not be described in detail here. As one example, various types of concentric feed nozzles could be employed. One such type is described by Hammeke in U.S. Pat. No. 4,724,299, referenced above. Hammeke describes a laser spray nozzle assembly, in which a laser beam passageway extends vertically through the housing of a nozzle body. The housing includes coaxial openings through which the laser can pass. A separate powder delivery system supplies powder from a direction perpendicular to the laser beam passageway, to an annular passage which communicates with the passageway. In this manner, the feed powder and the laser beam can converge at a common location. (In general, there are many different ways to feed powder through the laser consolidation system, and to the substrate. As one example, co-axial feeding of the powder is sometimes advantageous.) As in other laser consolidation systems, a melt pool is formed on an underlying work-piece, in a surface region coincident with the convergence of the laser beam and powder stream.

Another possible alternative relates to the manner in which the feed powder is delivered. In some preferred embodiments, the powder is fed into the melt pool on the substrate surface by multiple feed nozzles. For example, about 2 to 4 nozzles could be spaced equally around the circumference of the surface region at which deposition is taking place. Each nozzle could be supplied from a source similar to reservoir 102 in the embodiment of FIG. 3. A non-limiting example of a laser deposition system using multiple feed nozzles is provided in pending U.S. patent application Ser. No. 11/172,390, filed on Jun. 30, 2005, for Bernard Bewlay et al. The contents of that patent application are incorporated herein by reference. The use of multiple powder nozzles allows deposition of the ceramic feed material from a variety of directions. In some cases, this causes the material “build-up” to become more uniform, as compared to deposition from a single direction. In turn, greater uniformity and consistency in the melting and subsequent solidification of each layer being deposited can result in a more uniform microstructure for the completed positive feature.

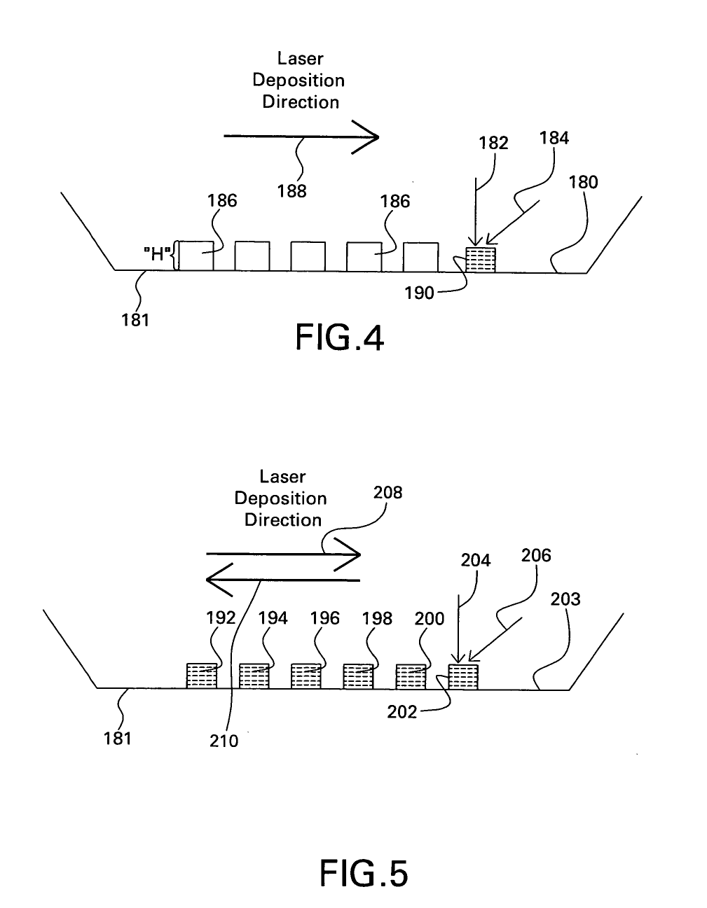

The deposition of the positive features to the substrate in layer-by-layer fashion can be carried out in various ways. FIG. 4 is a simplified depiction of the surface 180 of a suitable substrate 181, e.g., the recessed surface of a shroud. The laser consolidation apparatus is illustrated in simplified form, e.g., arrow 182 designates the laser beam, while arrow 184 designates the material feed, as described in detail previously. In this illustration, it is desirable to form a series of positive features 186, each having a height “H”. The positive features are deposited according to a “bump-to-bump” sequence. In other words, the laser deposition apparatus forms a single bump, layer-by-layer, before moving onto the next location, where the next bump is then completely formed in layer-by-layer fashion.

With continued reference to FIG. 4, movement of the laser system is illustrated by arrow 188. (As described above, the substrate itself could be moving instead of, or in coordination with, the laser system). The figure shows the last positive feature (190) in a given row being formed. Deposition will continue until feature 190 also rises to height H. From a 3-dimensional perspective, the formation of features in multiple rows or other patterns beyond the illustrated row of features (and not shown) could then be carried out.

As another alternative, the positive features could be formed in a “layer-to-layer” sequence. For example, a single layer for one feature or “bump” could be formed. The laser would then move onto the next bump, or selected site for a bump, depositing a single layer in that location. The laser would then move to the third, fourth, and fifth sites, etc., depositing a single layer. The laser would then be directed back to the first bump, to form a second layer, followed by movement to each successive bump, forming a second layer. The sequence would continue until each bump or feature is built up to a desired height.

FIG. 5 provides an illustration of this embodiment, in which features or bumps 192, 194, 196, 198, 200, and 202 are being formed on substrate 203. (The laser apparatus is depicted simply as laser beam 204 and material feed 206). Thus, after a single layer of feature 192 is formed, the laser advances (in direction-of-movement 208) to feature 194, to form a layer. The laser then moves to feature 196, 198, and so forth, forming single layers, continuing to feature 202.

At the designated end of this sequence, the laser could form a second layer on feature 202, and move back in the reverse direction (direction 210), forming second layers all the way back to feature 192. Alternatively, the laser could be immediately shifted back to feature 192, so as to repeat the second layer-deposition according to original direction 208. The overall deposition would continue until all of the features achieve the designated height “H”. This layer-by-layer technique might be especially useful when forming features which have relatively high vertical dimensions. As in the other embodiments, it should be noted that while one row of features 192-202 is illustrated, the laser could move through many rows of features which are being built, layer-by-layer, e.g., in a 3-dimensional pattern. Moreover, while movement of the laser apparatus itself is illustrated, the underlying substrate could also be moved according to a designated pattern. The computer control of the supporting platforms and laser apparatus allow for very great flexibility in designing a desired pattern of feature deposition.

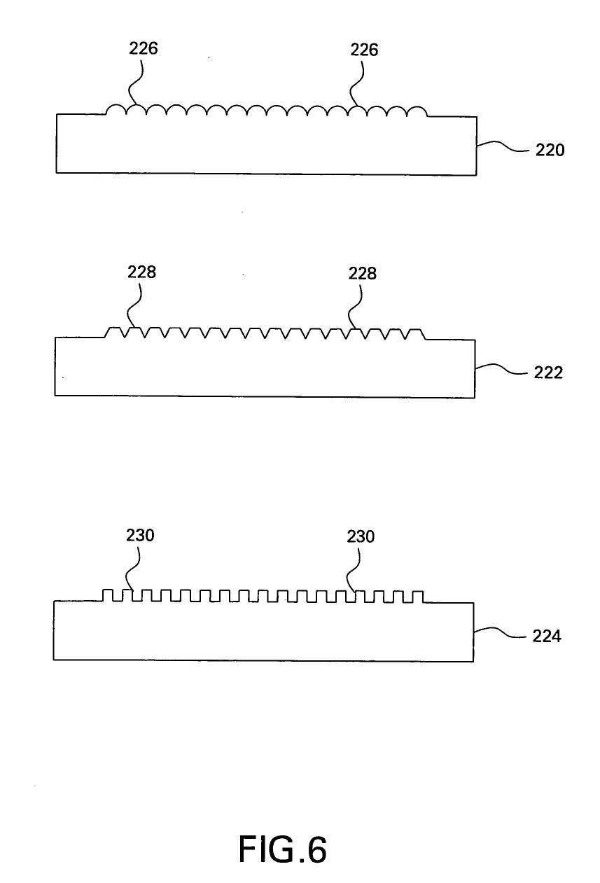

FIG. 6 is an illustrative, non-limiting compilation of different types of positive features which could be formed according to the process of the present invention. Three separate substrates, 220, 222, and 224, are depicted in cross-section. Each may represent the recessed back side of a shroud, for example. The positive features 226 on substrate 220 are in the general shape of hemispheres or domes, situated closely to each other. In the case of substrate 222, positive features 228 are in the general shape of frustums. The positive features 230 for substrate 224 are in the general shape of rectangular-faced raised elements. The spacing between the features can be controlled precisely by the CNC techniques discussed previously. In some embodiments, the positive features have an average height in the range of about 0.1 mm to about 2.0 mm, but this range can vary considerably.

As also noted above, features like those exemplified in FIG. 6 could function as a pattern of roughness elements, e.g., on various turbine components described herein. Details regarding the characteristics of surface roughness (e.g., in terms of “Rₐ” and “R_{z}” values) are known in the art. An exemplary reference is U.S. Pat. No. 6,468,669 (Hasz et al), which is incorporated herein by reference.

The particular pattern, shape and size of the positive features will depend on many of the factors discussed previously. For example, when the positive features are used to enhance cooling efficiency on or adjacent a part, the characteristics of the features are usually designed to provide maximum heat transfer capability. Those skilled in the art are familiar with techniques for measuring heat transfer characteristics. Exemplary techniques include fluid flow studies, discharge coefficient tests, computational fluid dynamics predictions, and the like. It should also be noted that the process described herein provides a very convenient technique for the formation of positive features which differ in size and shape from other positive features on the same surface, or on adjacent surfaces. This characteristic can be very useful in some instances, e.g., when the specific position of the feature relative to a particular gas flow stream can significantly influence cooling efficiency along the surface.

As alluded to previously, the shroud is typically attached to a turbine nozzle in the hot gas path section of a turbine. The shroud is used to minimize the gap between the nozzle and the adjacent, rotating turbine blades, so that the flow of “leakage air” is, in turn, minimized. The emplacement of these positive features (e.g., roughness elements) on the back side of the shroud advantageously improves the overall cooling potential of the shroud.

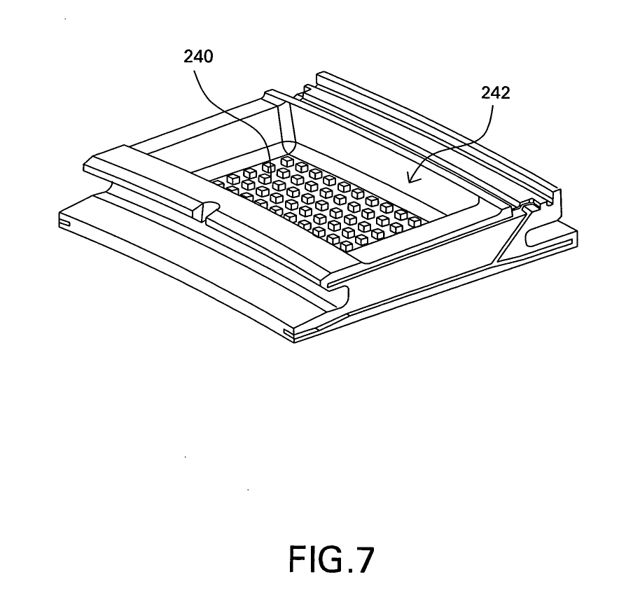

FIG. 7 is a view of a shroud, similar to FIG. 1. In this instance, the shroud includes positive features 240, formed according to embodiments of the present invention. (The features are depicted in exaggerated form, to make viewing easier). The features 240 function as roughness elements on the back side 242 of the shroud. As described previously, the shape, size, and pattern of the features can be precisely determined by way of the computer-controlled, laser consolidation system. Moreover, it should be emphasized that positive features 240 are formed on top of the underlying surface of the shroud. While a portion of the underlying surface is melted during the laser process, there is no removal of the surface material. Thus, the process described herein differs considerably from ECM processes, in which positive features are typically formed by the removal of material surrounding the feature.

It should also be emphasized that the positive features can be formed on various components associated with the actual shroud. Thus, the term “shroud component”, as used herein, is meant to include such associated or attached components. Non-limiting examples include shroud hangers, shroud supports, and nozzle bands. The use of positive features such as roughness elements on these other components can significantly enhance heat transfer characteristics.

Another embodiment of this invention relates to processes for repairing, replacing, or modifying positive features which have already been formed on a shroud component. For example, the process could be used if existing protuberances had somehow been damaged, or were out of specification in one or more dimensions. Laser consolidation would be employed to add material to the protuberances. This step could be used in combination with other conventional steps, e.g., machining and coating processes. Thus, in some cases, the pre-existing protuberances could be removed by grinding, prior to deposition of new protuberances. In other situations, new material could be deposited on top of existing protuberances. (The substrate on which the process is carried out should be one which is accessible to the laser beam/powder feed apparatus described previously).

In similar fashion, the process could be used whenever a protuberance (e.g., a turbulator) should be increased in size. The computer-controlled deposition would re-form the protuberance into a shape having the desired specifications. An advantage of using the laser deposition process is that the added material would have no detectable bond line or discontinuity with the protuberance after finishing, due to the welding phenomenon that has taken place.

While the invention has been described in connection with specific embodiments, they are intended for illustration only, and should not be construed as being limiting in any way. Thus, it should be understood that modifications can be made thereto, with the scope of the invention and the appended claims. All of the patents, patent applications, articles, and texts which are mentioned above are incorporated herein by reference.

What is claimed:

1. A process for the formation of positive features on the surface of a turbine shroud component, comprising the step of applying a feature-forming material to a selected portion of the component surface with a laser consolidation apparatus, according to a pre-selected shape and size for the positive features.

2. The process of claim 1, wherein the positive features have a shape selected from the group consisting of mounds, hemispheres, hemispherical sections, diamonds, cones, circular pins, plateaus, ridges, dimples, and elongated ribs.

3. The process of claim 1, wherein the positive features are in the form of turbulation.

4. The process of claim 1, wherein the positive features are in the form of a pattern of surface roughness.

5. The process of claim 1, wherein the positive features have an average height in the range of about 0.1 mm to about 2.0 mm.

6. The process of claim 1, wherein the positive features are applied in a selected pattern.

7. The process of claim 6, wherein the positive features comprise protuberances which are uniformly spaced from each other.

8. The process of claim 1, wherein the surface on which the positive features are applied is a back side, recessed cooling surface of the shroud.

9. The process of claim 1, wherein the positive features are formed of a metallic, ceramic, or cermet material.

10. The process of claim 9, wherein the metallic material is nickel-based, cobalt-based, iron-based, or titanium-based.

11. The process of claim 10, wherein the metallic material comprises a nickel-based or cobalt-based superalloy.

12. The process of claim 9, wherein the material which forms the positive features is substantially the same material as that which forms the turbine shroud component.

13. The process of claim 1, wherein multiple positive features are formed on the surface of the turbine shroud component, in selected locations on the surface, by coordinated movement of the laser consolidation apparatus or the shroud component surface, or by the coordinated movement of both the apparatus and the shroud component surface.

14. The process of claim 13, wherein each positive feature is completely formed, prior to formation of each additional positive feature.

15. The process of claim 13, wherein each positive feature is partially formed as a layer of a selected thickness, prior to the partial formation of an additional positive feature.

16. The process of claim 15, wherein a controlled, continuing sequence is established, so that an additional layer is added to each positive feature being formed, prior to movement to an additional positive feature being formed, until all of the features have been formed in a selected size and shape.

17. The process of claim 13, wherein the coordinated movement is computer-controlled.

18. The process of claim 17, wherein the coordinated movement is carried out with a multi-axis, computer numerically controlled (CNC) machine.

19. The process of claim 1, wherein the turbine shroud component is selected from the group consisting of turbine shrouds, shroud hangers, shroud supports, nozzle bands, and combinations thereof.

20. A gas turbine engine, comprising a shroud component which contains positive features formed according to the process of claim 1.

21. A process for the formation of positive features as a pattern of roughness on the back side surface of a turbine shroud component, comprising the following steps:
(i) melting a feature-forming material with a computer-controlled laser beam, and depositing the molten material onto the back side surface to form a first layer in the pattern of a first cross-section of the feature, the thickness of the first deposited layer corresponding to the thickness of the first cross-section;
(ii) melting a feature-forming material with the laser beam and depositing the molten material to form a second layer in the pattern of a second cross-section of the feature, at least partially overlying the first layer of deposited material, the thickness of the second deposited layer corresponding to the thickness of the second cross-section; and then
(iii) melting a feature-forming material with the laser beam and depositing the molten material to form successive layers in patterns of corresponding cross-sections of the feature, at least one of the successive cross-sections partially overlying the underlying cross-section, wherein the molten material is deposited and the successive layers are formed until the roughness pattern is complete.

22. The process of claim 21, wherein the feature-forming material is in the form of a powder.

23. The process of claim 21 wherein, during each step of melting the feature-forming material and depositing the molten material over a previously-deposited material, a portion of the previously-deposited material is melted, so as to form a welded bond between the layers.

24. The process of claim 21, wherein the feature-forming material for each step is directed to a laser beam spot on a surface of the feature being formed, through at least one delivery nozzle.

25. The process of claim 24, wherein the feature-forming material is directed to the feature surface through multiple delivery nozzles which are spaced around the laser beam spot.

26. A process for modifying the shape of at least one positive feature on a surface of a shroud component, comprising the step of applying additional feature-forming material by a laser consolidation process to the portion of an existing positive feature requiring shape-modification, according to a designated pattern, so that the feature is modified to a pre-selected shape.

27. The process of claim 26, wherein multiple positive features on a shroud component are modified in shape, so as to increase the heat transfer and cooling enhancement characteristics of the positive features.
